(19) United States
(12) Patent Application Publication
(10) Pub. No.: US 2026/0065442 A1
(43) Pub. Date: Mar. 5, 2026

(54) INPAINTING PROMPT GENERATION USING OBJECT PREDICTION

(71) Applicant: ADOBE INC., San Jose, CA (US)

(72) Inventors: Mang Tik Chiu, Bellevue, WA (US); Yuqian Zhou, Redmond, WA (US); Lingzhi Zhang, Philadelphia, PA (US); Zhe Lin, Clyde Hill, WA (US); Connelly Stuart Barnes, Bellenue, WA (US); Sohrab Amirghodsi, Seattle, WA (US); Elya Shechtman, Seattle, WA (US)

(21) Appl. No.: 18/819,609

(22) Filed: Aug. 29, 2024

(51) Int. Cl. G06T 5/77; G06T 7/10

(52) U.S. Cl. CPC G06T 5/77; G06T 7/10; G06T 2207/20081

(57) ABSTRACT

A method, apparatus, non-transitory computer readable medium, and system for generating suggested inpainting prompts include first obtaining an image depicting a first element. Embodiments then generate, using an embedding generation model, a text embedding based on the image and a noise input, where the text embedding represents the first element from the first image and a second element generated by the embedding generation model based on the noise input. Subsequently, embodiments generate a text prompt that includes the first element and the second element based on the text embedding.

### BACKGROUND

The following relates generally to image processing, and more specifically to generating suggested prompts for image inpainting. Image processing and computer vision focus on how machines can understand, interpret, and interact with visual data. Image processing algorithms range from simple tasks such as image enhancement and noise reduction, to more complex tasks such as object detection, face recognition, semantic segmentation, and image content generation. Image processing forms the foundation for computer vision, enabling machines to mimic human visual perception and interpret the world in a structured and meaningful way.

Inpainting is a type of image processing that involves predicting new image content within the context of an existing image. Techniques for inpainting include traditional methods such as patch-based and exemplar-based approaches, as well as modern deep learning techniques like generative adversarial networks (GANs) and diffusion models. These models predict missing regions by learning patterns from large datasets. In some cases, the generation may be conditioned on a text prompt, allowing for more precise and contextually relevant inpainting.

### SUMMARY

Embodiments of the inventive concepts described herein include systems and methods for generating inpainting prompts to suggest to a user. Embodiments include an image encoder that generates an image embedding of an input image. The input image includes a masked region, which a user may create using a brush tool to mark the area intended for new content. An embedding generation model then transforms this image embedding into a text embedding. While the image embedding represents the visual features of the input image, the text embedding translates these features into a format suitable for generating descriptive text. The model predicts possible elements that could be in the masked region and incorporates these predictions into the text embedding. The text embedding is subsequently decoded by a text decoder to produce a text prompt describing the predicted element. This text prompt can then be suggested to the user for use in a subsequent generative inpainting process.

A method, apparatus, non-transitory computer readable medium, and system for generating suggested prompts for image inpainting are described. One or more aspects of the method, apparatus, non-transitory computer readable medium, and system include obtaining an image depicting a first element; generating, using an embedding generation model, a text embedding based on the image and a noise input, wherein the text embedding represents the first element from the first image and a second element generated based on the noise input; and generating a text prompt based on the text embedding, wherein the text prompt includes the first element and the second element.

A method, apparatus, non-transitory computer readable medium, and system for generating suggested prompts for image inpainting are described. One or more aspects of the method, apparatus, non-transitory computer readable medium, and system include obtaining training data including a ground-truth text prompt describing a plurality of elements and a training image with a mask obscuring at least one of the plurality of elements and training, using the training data, an embedding generation model to generate a text embedding that represents the plurality of elements.

An apparatus, system, and method for generating suggested prompts for image inpainting are described. One or more aspects of the apparatus, system, and method include at least one processor; at least one memory storing instructions executable by the at least one processor; an embedding generation model comprising parameters stored in the at least one memory and trained to generate a text embedding from an image depicting a first element, wherein the text embedding represents the first element and a second element determined by the embedding generation model; and a text decoder comprising parameters stored in the at least one memory and trained to generate a text prompt based on the text embedding.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a diffusion model according to aspects of the present disclosure.

FIG. 4 shows an example of a pipeline for generating suggested inpainting prompts according to aspects of the present disclosure.

FIG. 5 shows an example of a method for generating text prompts from an image according to aspects of the present disclosure.

FIG. 6 shows an example of a method for providing suggested prompts to a user according to aspects of the present disclosure.

FIG. 7 shows an example of a pipeline for training a machine learning model according to aspects of the present disclosure.

FIG. 8 shows an example of a method for training a machine learning model according to aspects of the present disclosure.

FIG. 9 shows an example of a computing device according to aspects of the present disclosure.

### DETAILED DESCRIPTION

Object inpainting is frequently used in creative workflows. Historically, users would rely on manual techniques to fill in missing or masked regions of images. Traditional non-ML based techniques for inpainting include patch-based methods, where similar patches from the surrounding image are used to fill in the masked region, and exemplar-based methods, which use similar structures and textures from the image to recreate the missing content. These methods can require significant manual intervention and design expertise to achieve realistic results.

Recent developments in machine learning (ML) have enabled new workflows that automate the inpainting process. ML is a field of data processing that focuses on building algorithms capable of learning from and making predictions or decisions based on data. ML includes a variety of techniques, ranging from simple linear regression to complex neural networks. Generative models in ML are designed to generate new data samples that resemble a given dataset. Generative models are used in various fields, including sequence prediction, image generation, and object inpainting.

Recent advances in generative models, such as the Denoising Diffusion Probabilistic Model (DDPM), have enabled the generation of arbitrary objects based on text prompts. DDPMs iteratively refine noise into structured images, where the refinement can be conditioned on text features such as an encoding of the text prompt. Diffusion models are often used in object inpainting by, for example, filling a masked region of an image with noise, and then denoising the region to predict new content. The denoising may be conditioned by the text prompt to guide the generation to produce specific elements.

In some cases, users may benefit from prompt suggestions for text-guided inpainting. Object inpainting involves adding one or more new objects to an indicated region of an image. Existing models require users to provide explicit text prompts to describe their concepts, which can be challenging for inexperienced users who might not know what the generative models are capable of. It can also be time-consuming for experienced users to generate creative ideas or find a prompt that matches their vision.

Without explicit text prompts, existing models often default to sampling dominant content from their training datasets. For example, applying a mask to the sky in an image typically results in the model filling it with sky textures or clouds rather than more diverse elements like a bird. Some methods attempt to provide diversity while bypassing the text prompts by diversifying the outputs through noise based sampling, which generates random objects for inpainting. For example, one approach involves enforcing diversity by distancing multiple generation paths from each other. However, these methods sacrifice the precision of prompt guidance and can result in less controllable and predictable results for the user.

Embodiments of the present disclosure improve the accuracy of image inpainting systems by generating descriptive inpainting prompts. The generated prompts consider both the context of the input image and the elements surrounding the masked portion, as well as the shape of the mask itself. These prompts are sometimes referred to herein as “contextual prompts.” Embodiments include an embedding generation model that transforms an input image embedding of a masked image to generate a text embedding that includes an additional element based on the context of the image content and the shape of the mask. The text embeddings are then decoded into natural language prompts by a text decoder. Embodiments are trained to suggest diverse and meaningful prompts automatically as soon as the user places a mask on the image.

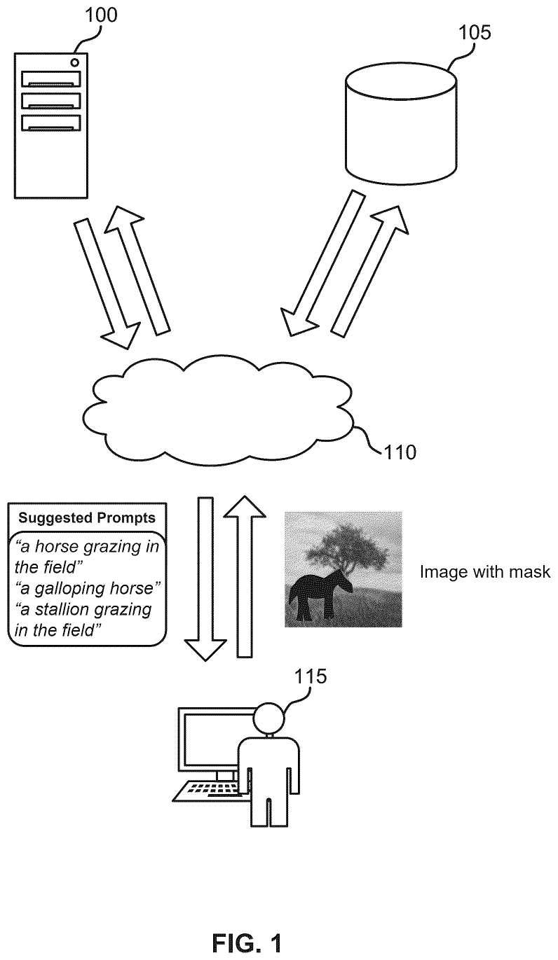

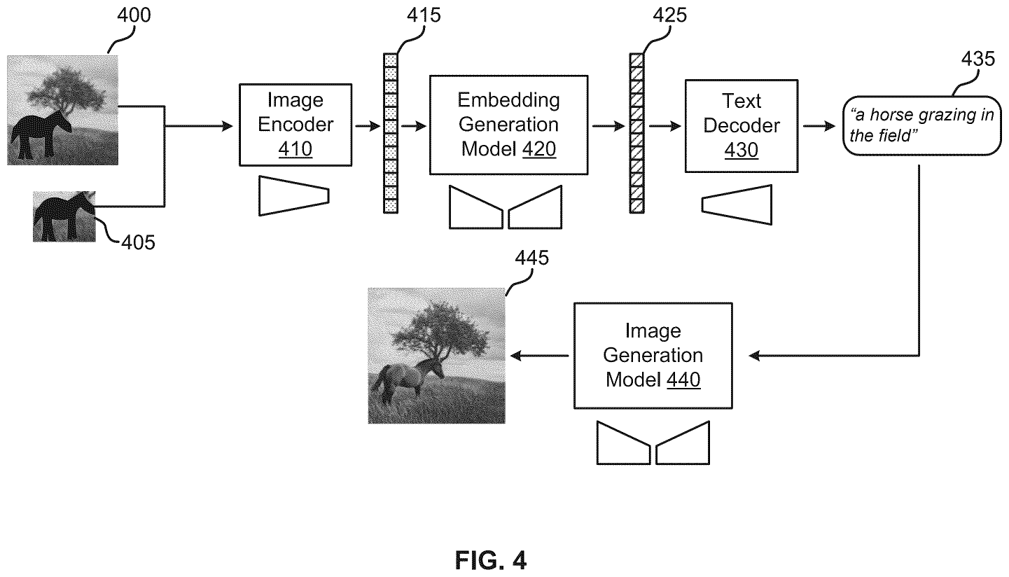

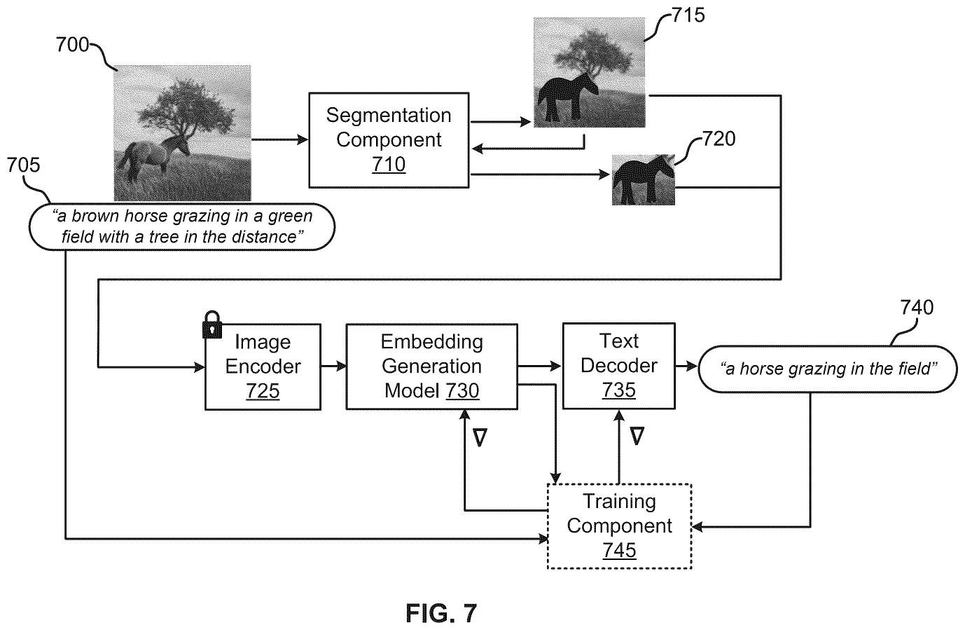

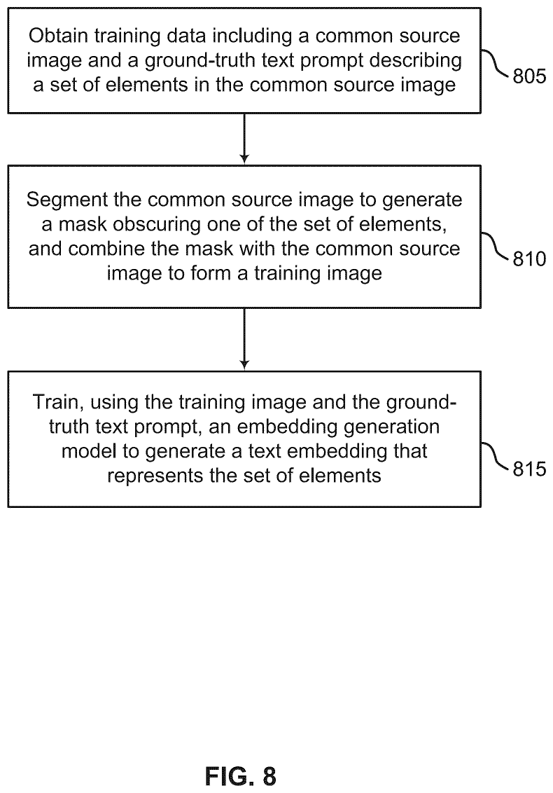

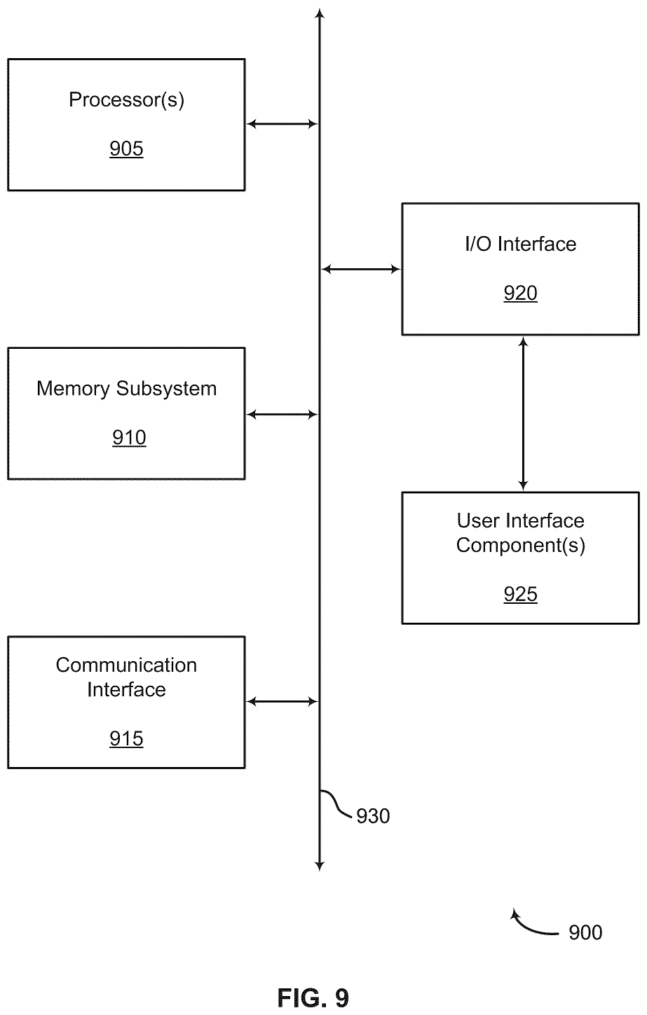

An image processing system is described with reference to FIGS. 1-3. Methods and pipelines for generating suggested infill prompts for a user and using the suggested infill prompts are described with reference to FIGS. 4-6. Methods and pipelines for training a machine learning model are described with reference to FIGS. 7-8. A computing device that may be used to implement an image processing apparatus is described with reference to FIG. 9.

### Image Processing System

An apparatus for generating suggested prompts for image inpainting is described. One or more aspects of the apparatus include at least one processor; at least one memory storing instructions executable by the at least one processor; an embedding generation model comprising parameters stored in the at least one memory and trained to generate a text embedding from an image depicting a first element, wherein the text embedding represents the first element and a second element determined by the embedding generation model; and a text decoder comprising parameters stored in the at least one memory and trained to generate a text prompt based on the text embedding.

Some examples of the apparatus, system, and method further include an image encoder configured to encode the image to obtain an image embedding. Some examples further include an image generation model configured to generate a synthetic image based on the text prompt. In some aspects, the embedding generation model comprises a diffusion model. Some examples further include a segmentation component configured to generate a mask that obscures a portion of the image corresponding to the second element.

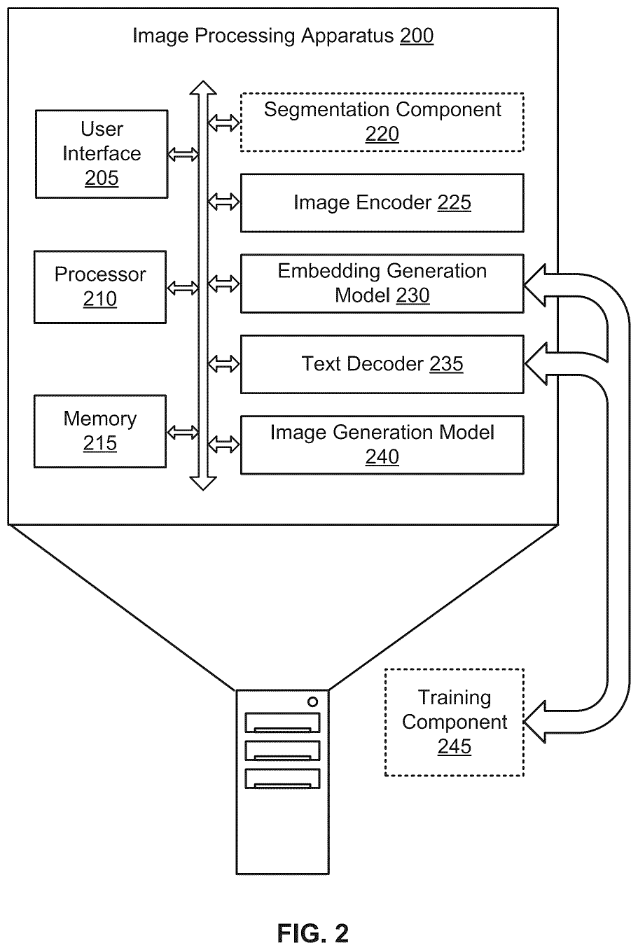

FIG. 1 shows an example of an image processing system according to aspects of the present disclosure. The example shown includes image processing apparatus 100, database 105, network 110, and user 115. Image processing apparatus 100 is an example of, or includes aspects of, the corresponding element described with reference to FIG. 2.

In an example process, user 115 applies a mask to an image. For example, the user may draw the mask onto an image within a multi-layer document editing software via a brush tool or the like. Then, the image with the mask is input to image processing apparatus 100, which generates one or more text prompts describing a possible element to be filled into the mask region. The image processing apparatus 100 may then suggest the generated prompts to the user 115. According to some aspects, the user may select one of the prompts to cause the system to perform a generative infilling process on the masked image based on the selected prompt.

Embodiments of image processing apparatus 100 are implemented on a server. A server provides one or more functions to users linked by way of one or more of the various networks 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus. Though some embodiments of image processing apparatus 100 are implemented on a server, embodiments are not necessarily limited thereto, and in some cases one or more components of image processing apparatus 100 may be implemented on an edge device such as a smartphone or PC.

Database 105 stores information used by the image processing system, such as model parameters, training data, user configuration and profile data, image and text embeddings, generated images, and the like. A database is an organized collection of data. For example, a database stores data in a specified format known as a schema. Database 105 may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

According to some aspects, image processing apparatus 100 obtains an image depicting a first element. Image processing apparatus 100 generates a caption describing a second element, which is predicted by the image processing apparatus 100. In some examples, image processing apparatus 100 obtains a mask indicating a region of the image, where the second element is based on the mask. In some aspects, the second element is not depicted in the image.

FIG. 2 shows an example of an image processing apparatus 200 according to aspects of the present disclosure. The example shown includes image processing apparatus 200, user interface 205, processor 210, memory 215, segmentation component 220, image encoder 225, embedding generation model 230, text decoder 235, image generation model 240, and training component 245.

A user interface 205 may enable a user to interact with a device. In some embodiments, the user interface 205 may include an audio device, such as an external speaker system, an external display device such as a display screen, or an input device (e.g., remote control device interfaced with the user interface 205 directly or through an IO controller module). In some cases, user interface 205 includes a graphical user interface 205 (GUI). In some examples, user interface 205 allows a user to upload and edit an image, and to identify a mask region in the image by, for example, drawing the region or “quick-selecting” an object in the image.

Processor 210 is configured to execute sets of instructions (“code”) that are used to implement various components of image processing apparatus 200. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate a memory array using a memory controller. In other cases, a memory controller is integrated into processor 210. In some cases, processor 210 is configured to execute computer-readable instructions stored in memory 215 to perform various functions. In some embodiments, processor 210 includes special purpose components for modem processing, baseband processing, digital signal processing, or transmission processing.

Memory 215 stores information used by image processing apparatus 200, such as model parameters, training data, embeddings, computer-readable instructions, and the like. Examples of a memory device include random access memory (RAM), read-only memory (ROM), or a hard disk. Examples of memory devices include solid state memory and a hard disk drive. In some examples, memory 215 is used to store computer-readable, computer-executable software including instructions that, when executed, cause processor 210 to perform various functions described herein. In some cases, memory 215 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 215 store information in the form of a logical state.

One or more components of image processing apparatus 200 may be implemented with an artificial neural network (ANN) structure. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Segmentation component 220 is configured to perform image segmentation. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics.

For example, given an input image during inference, segmentation component 220 may identify a masked region of the input image and create a bounding box around the masked region. Then, the segmentation component 220 may generate an additional image that is cropped to this bounding box as input for image encoder 225. During a training phase, segmentation component 220 may perform a panoptic image segmentation operation to identify one or more elements in a common source image, and then automatically form a mask over the one or more elements to generate a training image (with the mask included) from the common source image. Segmentation component 220 is an example of, or includes aspects of, the corresponding element described with reference to FIG. 7. In at least one embodiment, segmentation component 220 is implemented on an apparatus different from image processing apparatus 200.

Image encoder 225 is configured to generate an image embedding from an input image. An embedding, or embedding vector, is a numerical representation that captures the semantic meaning of an input. Embodiments of image encoder 225 include the CLIP image encoder, which is based on both convolutional neural network and transformer architecture subcomponents.

Contrastive Language-Image Pre-Training (CLIP) is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

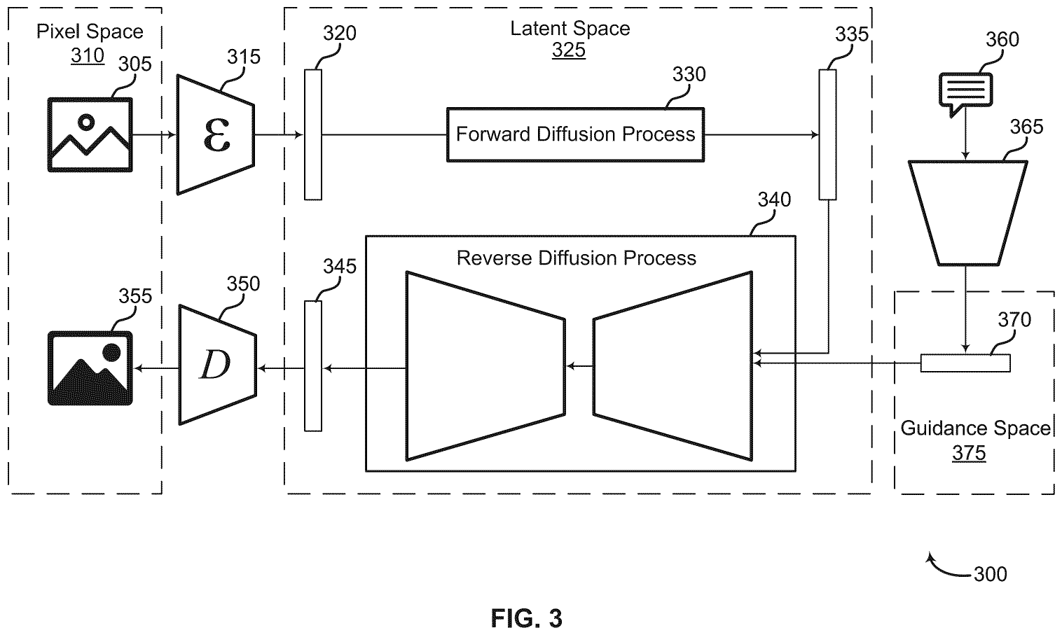

According to some aspects, image encoder 225 includes a vision transformer. The vision transformer may perform attention operates on embeddings produced by CNNs from patches of an input image. A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships. Image encoder 225 is an example of, or includes aspects of, the corresponding element described with reference to FIGS. 3, 4, and 7.

Embedding generation model 230 is trained to translate an input image embedding into a text embedding, while further predicting an additional element during the process. The “additional element” is a concept of an object or other image element that was not initially represented in the image embedding. Embodiments of embedding generation model 230 include a diffusion model. The embedding generation model 230 begins with the input image embedding and iteratively de-noises it to produce a text embedding that incorporates the predicted additional element. In some embodiments, the embedding generation model 230 may instead begin with a noise sample, and iteratively de-noise the noise sample using the input image embedding as guidance features. A diffusion model, which will be described in detail with reference to FIG. 3, refines the image embedding through successive de-noising steps, resulting in the final text embedding.

Embodiments of the image processing system receive an input image depicting a first element. According to some aspects, embedding generation model 230 generates a text embedding that represents the first element and a second element determined by the embedding generation model 230. In some examples, embedding generation model 230 obtains a noise input. In some examples, embedding generation model 230 performs a diffusion process on the noise input. Embedding generation model 230 is an example of, or includes aspects of, the corresponding element described with reference to FIGS. 4 and 7.

According to some aspects, text decoder 235 generates a text prompt based on the text embedding produced by embedding generation model 230, where the text prompt includes the first element and the second element. The text decoder 235 generates the text prompt by decoding the text embedding. Embodiments of text decoder 235 include a pre-trained transformer-based decoder model such as the GPT-2 decoder, which is then further fine-tuned in the training process described with reference to FIG. 7. Embodiments of text decoder 235 is an example of, or includes aspects of, the corresponding element described with reference to FIGS. 4 and 7.

Image generation model 240 is configured to generate images and to perform generative inpainting using the text prompt. According to some aspects, image generation model 240 generates a synthetic image based on the text prompt, where the synthetic image includes the first element and the second element. For example, image generation model 240 may generate a synthetic image that includes the image elements that were not obfuscated by the mask in the input image, as well as the additional element suggested by the text prompt. Embodiments of image generation model 240 are based on a diffusion model, similar to embedding generation model 230. Image generation model 240 is an example of, or includes aspects of, the corresponding elements described with reference to FIGS. 3-4.

Training component 245 updates parameters of image processing apparatus 200 during a training phase. For example, training component 245 may update parameters of embedding generation model 230 and text decoder 235. According to some aspects, training component 245 trains, using a training data, the embedding generation model 230 to generate a text embedding that represents an entire set of elements from a common source image, despite one of the elements being obfuscated by a training mask. In some examples, training component 245 computes a diffusion loss based on the ground-truth text prompt. In some examples, training component 245 updates parameters of the embedding generation model 230 based on the diffusion loss. In some examples, training component 245 trains a text decoder 235 to generate a text prompt based on the text embedding. In some examples, training component 245 computes a cross-entropy loss based on the ground truth text prompt. In some examples, training component 245 updates parameters of the text decoder 235 based on the cross-entropy loss. Training component 245 is an example of, or includes aspects of, the corresponding element described with reference to FIG. 7.

FIG. 3 shows an example of a diffusion model according to aspects of the present disclosure. Herein, both an embedding generation model and an image generation model of an image processing system may both be based on a diffusion model. For example, the embedding generation model may be configured to iteratively refine a noise sample into a text embedding within a multimodal embedding space. The image generation model may be configured to iteratively refine a noise sample (or an image masked partially by noise) into image data.

The example shown includes guided latent diffusion model 300, original image 305, pixel space 310, image encoder 315, original image features 320, latent space 325, forward diffusion process 330, noisy features 335, reverse diffusion process 340, denoised image features 345, image decoder 350, output image 355, text prompt 360, text encoder 365, guidance features 370, and guidance space 375. Image encoder 315 is an example of, or includes aspects of, the corresponding element described with reference to FIGS. 2, 4, and 7. Text prompt 360 is an example of, or includes aspects of, the corresponding element described with reference to FIG. 4.

In some examples, diffusion models are based on a neural network architecture known as a U-Net. The U-Net takes input features having an initial resolution and an initial number of channels and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In the case of the image generation model, the text prompt may be encoded by a text encoder to generate guidance features for the generative inpainting process. In the case of the embedding generation model, an image embedding from an image encoder may be used as the guidance features for the generation of the text embedding. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x)=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x₇ represent noisy images, and x represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

### Generating Prompt Suggestions From a Masked Image

A method for generating suggested prompts for image inpainting is described. One or more aspects of the method include obtaining an image depicting a first element; generating, using an embedding generation model, a text embedding that represents the first element and a second element determined by the embedding generation model; and generating a text prompt based on the text embedding, wherein the text prompt includes the first element and the second element. In some aspects, the embedding generation model is trained using training data including a ground truth text prompt describing a plurality of elements and a training image with a mask obscuring at least one of the plurality of elements.

In some aspects, the second element is not depicted in the image. Some examples of the method, apparatus, non-transitory computer readable medium, and system further include obtaining a mask indicating a region of the image, wherein the second element is based on the mask. Some examples further include generating a local image that includes the region indicated by the mask and excludes a background region of the image, wherein the text embedding is generated based on the image and the local image.

Some examples of the method, apparatus, non-transitory computer readable medium, and system further include encoding the image to obtain an image embedding, wherein the text embedding is generated based on the image embedding. In some aspects, the image embedding represents the first element and not the second element.

Some examples of the method, apparatus, non-transitory computer readable medium, and system further include obtaining a noise input. Some examples further include performing a diffusion process on the noise input. Some examples further include generating a synthetic image based on the text prompt, wherein the synthetic image includes the first element and the second element.

FIG. 4 shows an example of a pipeline for generating suggested inpainting prompts according to aspects of the present disclosure. The example shown includes input image 400, cropped input image 405, image encoder 410, image embedding 415, embedding generation model 420, text embedding 425, text decoder 430, text prompt 435, image generation model 440, and inpainted image 445. Image encoder 410 is an example of, or includes aspects of, the corresponding element described with reference to FIGS. 2, 3, and 7. Embedding generation model 420 is an example of, or includes aspects of, the corresponding element described with reference to FIGS. 2 and 7. Text decoder 430 is an example of, or includes aspects of, the corresponding element described with reference to FIGS. 2 and 7. Image generation model 440 is an example of, or includes aspects of, the corresponding element described with reference to FIG. 2.

Given an image/and a mask M, embodiments are configured to generate K text prompts T_{k,k∈{1 . . . K}}, where each text prompt describes a plausible element to be inserted into the masked region. Unlike conventional methods, which approach this problem as a deterministic process and therefore only predict a single object category, embodiments of the present disclosure perform a generation process using embedding generation model 420. The final generated text prompt 435 can be presented to a user for modifications or direct use with image generation model 440.

In this example, a user provides image/and a mask M. The mask may be drawn onto the image in a document editing software. Embodiments combine I and M to form a masked image I_{M}=I⊙M, e.g. input image 400. Then, image encoder 410, which may be a frozen CLIP-image encoder, extracts visual features from input image 400 to produce image embedding 415. In some embodiments, input image 400 is further cropped to the bounding box of the mask to form cropped input image 405, which is further encoded and combined into image embedding 415. The shape of the mask is considered by the trained embedding generation model 420. In some embodiments, the mask is dilated to allow greater creativity in prompt suggestions. In some embodiments, a dilated convex hull is used for even greater creativity and looser adherence to the mask shape. In at least one embodiment, the bounding box itself is used for maximum diversity. In some cases, these operations may be performed on M according to a configurable “diversity parameter.” After encoding I_{M}, embodiments input image embedding 415 into embedding generation model 420 as guidance features. Additional detail regarding generative diffusion processes with guidance features is provided with reference to FIG. 3.

Embedding generation model 420 then generates text embedding 425 with a generative diffusion process. This process creates text embedding 425 with a latent representation of an element for the masked region. Then, text decoder 430 decodes text embedding 425 to produce a natural language text, text prompt 435, that describes the element. At this point, the system may provide the text prompt 435 to a user as a suggestion, and the operation of the system may be completed. However, in some embodiments, the user may proceed with text prompt 435 to perform an inpainting process using image generation model text prompt 440 to generate inpainted image 445.

In one embodiment, embedding generation model 420 does not generate a text embedding in a multimodal embedding space such as the CLIP space, but instead generates a category vector. In this embodiment, the final output layer of embedding generation model 420 is a sequence of probabilities that correspond to explicit, known categories of objects. Then, the text prompt 435 is simply the category label with the highest probability, or multiple suggested prompts may be used by using the top-K highest probabilities. However, in most embodiments, embedding generation model 420 generates text embedding 425 as a latent vector which is understandable (e.g., decodable) by a transformer-based text decoder 430.

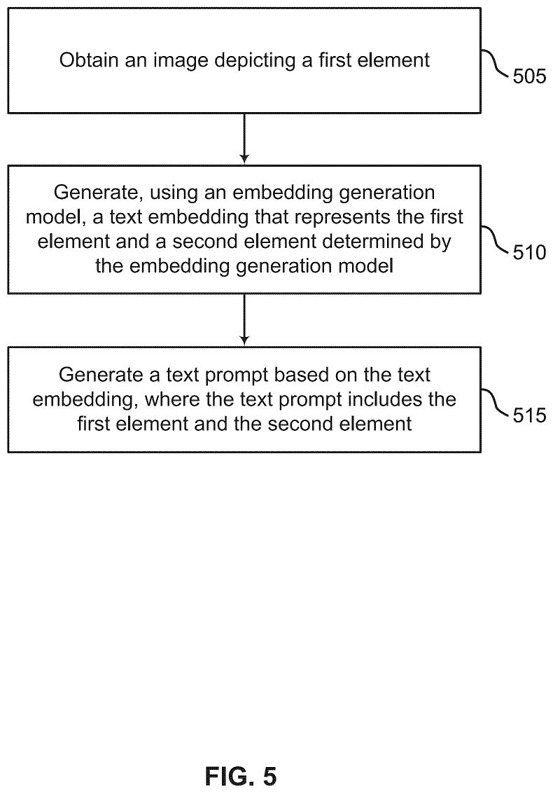

FIG. 5 shows an example of a method 500 for generating text prompts from an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains an image depicting a first element. In some cases, the operations of this step refer to, or may be performed by, an image processing apparatus as described with reference to FIGS. 1 and 2. For example, a user may specify the image within a user interface as described with reference to FIG. 2.

At operation 510, the system generates, using an embedding generation model, a text embedding that represents the first element and a second element determined by the embedding generation model. In some cases, the operations of this step refer to, or may be performed by, an embedding generation model as described with reference to FIGS. 2, 4, and 7. According to some aspects, the second element is not visible from the obtained image. For example, a user may obscure a region corresponding to the second element by drawing or otherwise creating a mask in the region. The user may do so, for example, during an inpainting task, in which the user desires to replace the content within the region with new content.

At operation 515, the system generates a text prompt based on the text embedding, where the text prompt includes the first element and the second element. In some cases, the operations of this step refer to, or may be performed by, a text decoder as described with reference to FIGS. 2, 4, and 7. The system may provide the text prompt to the user as a suggested description of the content to create during inpainting. The user may use the text prompt as is or provide their own modifications to the text prompt before proceeding to inpaint the masked region using an image generation model.

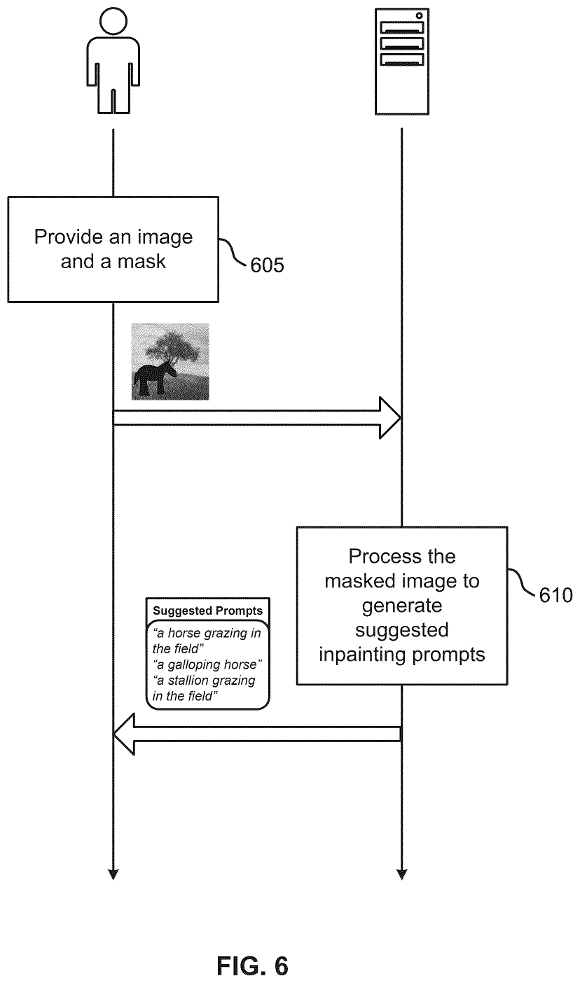

FIG. 6 shows an example of a method 600 for providing suggested prompts to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, a user provides an image and, optionally, a mask to the system. The user may, for example, draw on a mask shape onto the image or use a quick-select tool to identify a segment of the image for the mask. The user may do so via a user interface as described with reference to FIG. 2. The image can include a first element, i.e., an object such as the tree or the field in the depicted example.

At operation 610, the system processes the image to generate suggested inpainting prompts. The system may, for example, generate an image embedding from the input image and mask, generate a text embedding from the image embedding, and decode the text embedding to generate an inpainting prompt. The text embedding may represent a second element, such as the horse grazing in the field in the depicted example. In some cases, the second element is not present in the input image, as the horse is not in the original input image.

Rather, an embedding generation model may be used to generate the text embedding based on a noise input such as a seed parameter, and the second element can be determined generatively based on the context of the image, the mask, and the noise input. According to some aspects, the system may change a seed parameter of an embedding generation model to produce a different suggested inpainting prompt, or may adjust the mask using morphological operations, bounding boxes, or convex hulls to produce varying suggested inpainting prompts.

### Training

A method for training a machine learning model is described. One or more aspects of the method include obtaining training data including a ground-truth text prompt describing a plurality of elements and a training image with a mask obscuring at least one of the plurality of elements, and training, using the training data, an embedding generation model to generate a text embedding that represents the plurality of elements.

Some examples of the method, apparatus, non-transitory computer readable medium, and system further include generating the ground-truth text prompt and the training image based on a common source image. Some examples further include segmenting the common source image, wherein the mask is based on the segmentation.

Some examples of the method, apparatus, non-transitory computer readable medium, and system further include computing a diffusion loss based on the ground-truth text prompt. Some examples further include updating parameters of the embedding generation model based on the diffusion loss. Some further include training a text decoder to generate a text prompt based on the text embedding.

Some examples of the method, apparatus, non-transitory computer readable medium, and system further include computing a cross-entropy loss based on the ground truth text prompt. Some examples further include updating parameters of the text decoder based on the cross-entropy loss.

FIG. 7 shows an example of a pipeline for training a machine learning model according to aspects of the present disclosure. The example shown includes source image 700, ground-truth caption 705, segmentation component 710, masked source image 715, cropped and masked source image 720, image encoder 725, embedding generation model 730, text decoder 735, predicted text prompt 740, and training component 745.

Segmentation component 710 is an example of, or includes aspects of, the corresponding element described with reference to FIG. 2. Image encoder 725 is an example of, or includes aspects of, the corresponding element described with reference to FIGS. 2-4. Embedding generation model 730 is an example of, or includes aspects of, the corresponding element described with reference to FIGS. 2 and 4. Text decoder 735 is an example of, or includes aspects of, the corresponding element described with reference to FIGS. 2 and 4. Training component 745 is an example of, or includes aspects of, the corresponding element described with reference to FIG. 2.

Embodiments of the present disclosure train an embedding generation model 730 to translate input image embeddings into text embeddings for better alignment in the text space, and to be of a form that is decodable by text decoder 735. In some embodiments, the embedding generation model 730 is a diffusion model, and the image embeddings are CLIP-image embeddings e_{M} (the ‘M’ denotes “masked image”) and the text embeddings are CLIP-text embeddings e_{T}. After training the embedding generation model 730, the generated text embeddings encode a description of a potential candidate for object insertion into a masked region. According to some aspects, a pre-training phase of the diffusion model used by embedding generation model 730—that is, a large-scale pretraining phase unrelated to the element prediction training described herein—enables a diverse set of output object descriptions within the text embeddings.

In an example training process, segmentation component 710 processes source image 700 to automatically identify a region of the source image 700 to obscure. For example, segmentation component 710 may perform a panoptic image segmentation to identify a foreground “thing” or background “stuff” in the image, and then mark over the identified element with a solid color such as gray or black, thereby forming masked source image 715. In some embodiments, the segmentation component 710 crops masked source image 715 to yield cropped and masked source image 720, and both images are input to image encoder 725.

According to some aspects, having a both a global and local crop of the image content with respect to the masked region enables the model to consider both contexts. For example, if only the global crop is used, in some cases the masked area may be small or off-centered, and the embedding generation model 730 may ignore the mask and generate concepts that are related to only the global context or other objects in the image. If only the local crop is used, the model may lack global context and generate concepts that are irrelevant to the original image. Therefore, in some embodiments, the system concatenates masked source image 715 and cropped and masked source image 720 together form the input to image encoder 725.

Image encoder 725 then generates an image embedding, which is then input to embedding generation model 730. Embodiments of embedding generation model 730 include a diffusion-based model, such as the one described with reference to FIG. 3. The embedding generation model 730 then “predicts”, using the image embedding as guidance, a text embedding that encodes the new element for the masked region. This prediction is made in a generative process, such as the generative reverse diffusion process described with FIG. 3.

According to some aspects, embodiments train the embedding generation model 730 by comparing its text embedding prediction to an embedding of ground-truth caption 705. The ground-truth caption 705 may describe, for example, a plurality of elements from source image 700. However, the image embedding that was input to embedding generation model 730 is an embedding of an image that has at least one element obscured by a mask. By training the embedding generation model 730 to align is text embedding prediction with the embedding of ground-truth caption 705, the training process encourages embedding generation model 730 to generate a new element for the masked region to fill in the missing information.

In some examples, embodiments encode the ground-truth caption 705 using a CLIP-text encoder to obtain a caption embedding

$${x}_{0}^{d} ,$$

where ‘d’ denotes “description”, and 0 denotes the 0^{th} step in adding noise. During a training forward diffusion process, the system adds noise to produce a noised embedding

$${x}_{t}^{d}$$

at timestep t.

Embedding generation model 730 then estimates

$${x}_{0}^{d}$$

conditioned on the noise embedding, timestep, and masked-image embedding. In some embodiments, training component 745 computes a mean-squared error (MSE) loss based on the differences between the estimation and the ground-truth noised embedding:

$$ℒ = 𝔼 [ {‖ {x}_{0}^{d} - {F}_{θ} ( {x}_{t}^{d} , t , {e}_{M} ) ‖}_{2}^{2} ] \qquad ( 3 )$$

where [symbol] is the loss, F_{θ} is the embedding generation model 730, t is the timestep, and e_{M} is the image embedding. The training component 745 then backpropagates this loss to the embedding generation model 730 to update its parameters.

Embodiments further train text decoder 735. The text embedding prediction is sent to text decoder 735 which decodes it to generate predicted text prompt 740. Predicted text prompt 740 is compared to ground-truth caption 705, and training component 745 computes a cross-entropy loss based on this comparison. In an example, the text decoder 735 tries to predict the next text token given the text embedding prediction as a prefix and previous text tokens. An example of the objective function for the text decoder 735 during training is given by Equation (4):

$${max}_{ϕ} {\sum }_{i = 1}^{L} log {p}_{ϕ} ( {w}_{i} \vert {x}_{0}^{d} , {w}_{0} , {w}_{1} , ... , {w}_{i - 1} ) \qquad ( 4 )$$

where φ is the parameters of the text decoder 735, L is the token length of the sentence, and wᵢ, i∈[1 . . . L] are the text tokens of the predicted text prompt 740.

FIG. 8 shows an example of a method 800 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including a common source image and a ground-truth text prompt describing a set of elements in the common source image. In some cases, the operations of this step refer to, or may be performed by, an image processing apparatus as described with reference to FIGS. 1 and 2. An example of the common source image and the ground-truth text prompt is depicted in FIG. 7.

At operation 810, the system segments the common source image to generate a mask obscuring one of the set of elements and combining the mask with the common source image to form a training image. In some cases, the operations of this step refer to, or may be performed by, a segmentation component as described with reference to FIGS. 2 and 7. For example, referring to FIG. 7, the segmentation identifies a foreground animal in the image, and obscures the animal using a mask. This mask, which may be a solid color shape, is “burned in” to the image to form the training image. Embodiments are not necessarily limited thereto, however, and the training image may include separate channels for image content and for the mask.

At operation 815, the system trains, using the training image and the ground-truth text prompt, an embedding generation model to generate a text embedding that represents the set of elements. In some cases, the operations of this step refer to, or may be performed by, a training component as described with reference to FIG. 2. According to some aspects, the training component computes an MSE loss based on a comparison between an embedding of the ground-truth text prompt and a text embedding predicted by the embedding generation model, and updates parameters of the embedding generation model by backpropagating the MSE loss. Additional detail regarding the training process is provided with reference to FIG. 7.

FIG. 9 shows an example of a computing device 900 according to aspects of the present disclosure. The example shown includes computing device 900, processor(s) 905, memory subsystem 910, communication interface 915, I/O interface 920, user interface component(s), and channel 930.

In some embodiments, computing device 900 is an example of, or includes aspects of, image processing apparatus 100 of FIG. 1. In some embodiments, computing device 900 includes one or more processors 905 are configured to execute instructions stored in memory subsystem 910 to obtain an image depicting a first element; generate, using an embedding generation model, a text embedding that represents the first element and a second element determined by the embedding generation model; and generate a text prompt based on the text embedding, wherein the text prompt includes the first element and the second element.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (e.g., a remote-control device interfaced with a user interface directly or through the I/O controller), or a combination thereof. In some cases, user interface component(s) 925 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image depicting a first element;
generating, using an embedding generation model, a text embedding based on the image and a noise input, wherein the text embedding represents the first element from the first image and a second element generated based on the noise input; and
generating a text prompt based on the text embedding, wherein the text prompt includes the first element and the second element.

2. The method of claim 1, further comprising:
obtaining a mask indicating a region of the image, wherein the second element is based on the mask.

3. The method of claim 2, further comprising:
generating a local image that includes the region indicated by the mask and excludes a background region of the image, wherein the text embedding is generated based on the image and the local image.

4. The method of claim 1, wherein:
the second element is not depicted in the image.

5. The method of claim 1, further comprising:
encoding the image to obtain an image embedding, wherein the text embedding is generated based on the image embedding.

6. The method of claim 5, wherein:
the image embedding represents the first element and not the second element.

7. The method of claim 1, wherein generating the text embedding comprises:
performing a diffusion process on the noise input.

8. The method of claim 1, further comprising:
generating a synthetic image based on the text prompt, wherein the synthetic image includes the first element and the second element.

9. The method of claim 1, wherein:
the embedding generation model is trained using training data including a ground truth text prompt describing a plurality of elements and a training image with a mask obscuring at least one of the plurality of elements.

10. A method for training a machine learning model, the method comprising:
obtaining training data including a ground-truth text prompt describing a plurality of elements and a training image with a mask obscuring at least one of the plurality of elements; and
training, using the training data, an embedding generation model to generate a text embedding that represents the plurality of elements.

11. The method of claim 10, wherein obtaining the training data comprises:
generating the ground-truth text prompt and the training image based on a common source image.

12. The method of claim 11, wherein generating the training image comprises:
segmenting the common source image, wherein the mask is based on the segmentation.

13. The method of claim 10, wherein training the embedding generation model comprises:
computing a diffusion loss based on the ground-truth text prompt; and
updating parameters of the embedding generation model based on the diffusion loss.

14. The method of claim 10, further comprising:
training a text decoder to generate a text prompt based on the text embedding.

15. The method of claim 14, wherein training the text decoder comprises:
computing a cross-entropy loss based on the ground truth text prompt; and
updating parameters of the text decoder based on the cross-entropy loss.

16. An apparatus comprising:
at least one processor;
at least one memory storing instructions executable by the at least one processor;
the apparatus further comprising an embedding generation model comprising parameters stored in the at least one memory and trained to generate a text embedding from an image depicting a first element, wherein the text embedding represents the first element and a second element determined by the embedding generation model; and
a text decoder comprising parameters stored in the at least one memory and trained to generate a text prompt based on the text embedding.

17. The apparatus of claim 16, further comprising:
an image encoder configured to encode the image to obtain an image embedding.

18. The apparatus of claim 16, further comprising:
an image generation model configured to generate a synthetic image based on the text prompt.

19. The apparatus of claim 16, further comprising:
a segmentation component configured to generate a mask that obscures a portion of the image corresponding to the second element.

20. The apparatus of claim 16, wherein:
the embedding generation model comprises a diffusion model.
